(19) United States
(12) Patent Application Publication
(10) Pub. No.: US 2019/0069125 A1
(43) Pub. Date: Feb. 28, 2019

(54) DETERMINING LOCATION OF A USER DEVICE IN A WIRELESS COMMUNICATION NETWORK BASED ON LOCATION INFORMATION STORED ON THE USER DEVICE

(71) Applicant: T-Mobile USA, Inc., Bellevue, WA (US)

(72) Inventor: Vinod Ravichandran, Renton, WA (US)

(73) Assignee: T-Mobile USA, Inc.

(21) Appl. No.: 15/692,792

(22) Filed: Aug. 31, 2017

(51) Int. Cl. H04W 4/02; H04W 8/18; H04L 29/08

(52) U.S. Cl. CPC H04W 4/02; H04W 88/02; H04L 67/2842; H04W 8/183

(57) ABSTRACT

A method of providing services to a portable electronic device by a wireless communication network based upon a cached location or an actual location of the portable electronic device. A location of the mobile device is determined by the mobile device. The location is saved in one of (i) memory included in the mobile device or (ii) cache included in the mobile device. The mobile device makes a request for a service within the wireless communication network. The saved location is provided to the wireless communication network, or the actual location of the mobile device is provided to the wireless communication network. Use of either of the locations is based upon configuration of the mobile device and/or application logic, which may be programmed in a way that either of the locations may be used, and in any frequency, based on the type of interaction with the wireless communication network.

### BACKGROUND

In recent years, mobile telecommunication devices have advanced from offering simple voice calling services within wireless networks to providing users with many new features. Mobile telecommunication devices now provide messaging services such as email, text messaging, and instant messaging; data services such as Internet browsing; media services such as storing and playing a library of favorite songs; location services; and many others. In addition to the new features provided by the mobile telecommunication devices, users of such mobile telecommunication devices have greatly increased. Such an increase in users is only expected to continue and in fact, it is expected that there could be a growth rate of twenty times more users in the next few years alone.

Generally, mobile telecommunication devices in the form of portable electronic devices use services in the wireless communication network by placing telephone calls are billed based on minutes “talking.” Thus, an operator of the wireless communication network utilizes call detail records (CDRs) for billing purposes. However, when a user of a mobile telecommunication device utilizes a third-party application in the wireless communication network, use of the application is generally not based on minutes but rather based on data usage. When billing users of mobile telecommunication devices for services in the wireless communication network, the operator of the wireless communication network generally bills for minutes and/or data usage based upon the location of a mobile telecommunication device within the wireless communication network. For example, generally a flat price (e.g., unlimited use) may be provided for minutes and/or data usage for operation of mobile telecommunication devices within the United States, or a lower price per minute or per unit of data usage for operation of mobile telecommunication devices within the United States. However, if the mobile telecommunication device is located external to the United States (e.g., located internationally), then the minutes and/or data usage may be billed at a higher rate (e.g., for roaming). Thus, in order to properly bill for services provided to the mobile telecommunication device, the operator of the wireless communication network needs to know the location of the mobile telecommunication device.

When the mobile telecommunication device is placing a call, and therefore using minutes for talking and thereby billing purposes, the mobile telecommunication device location may be determined utilizing a cell global identity (CGI), which identifies a cell within which the mobile telecommunication device is located. However, when the mobile telecommunication device is utilizing a third-party application for accessing service within the wireless communication network, the third-party application does not have access to the CGI. Therefore, the third-party applications may utilize a global positioning system (“GPS”) feature of the mobile device in order to determine the mobile telecommunication device's location. Additionally, some mobile telecommunication devices can only determine location using GPS or cell tower triangulation. However, utilizing the GPS to determine and/or maintain the location of the mobile telecommunication device drains a battery of the mobile telecommunication device. Furthermore, determining the location of the mobile telecommunication device prior to providing service to the mobile telecommunication device can delay provision of the service to the mobile telecommunication device.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIGS. 1A and 1B illustrate a wireless communication network, in accordance with various embodiments.

FIG. 2 is a flowchart illustrating a method of providing services to a portable electronic device by the wireless communication network of FIGS. 1A and 1B, in accordance with various embodiments.

FIG. 3 illustrates a component level view of an example mobile device configured for use in the wireless communication network of FIG. 1.

FIG. 4 illustrates a component level view of a server configured for use in the arrangement of FIG. 1 to provide various services of the wireless communication network of FIG. 1.

### DETAILED DESCRIPTION

Described herein is a wireless communication network and user devices for use in the wireless communication network that includes techniques and architecture for determining a location of the user devices based on location information stored on the user devices. For example, user devices may store a recent location of the user device in a cache (or memory) of the user device. When a user of the user device desires service from the wireless communication network, the user device may provide the cached (stored) location to the operator of the wireless communication network. Based upon the cached location, the operator of the wireless communication network may determine an initial billing procedure for the user device and provide the service to the user device. This can minimize delay of the provision of the service to the user device.

In configurations, a location application on the user device may store a location of the user device in cache (or memory) on the user device. When utilizing the location application on the user device, the user may be prompted for permission for the location application to operate and store one or more locations of the user device in the cache or memory. Generally, the location application only stores a single, preferably recent, location, in the cache or memory. The location application, in configurations, may also request the user device to determine the current location of the user device and store it in the cache.

When the user device requests service within the wireless communication network, e.g., wishes to make a call thereby utilizing minutes, or utilize an application, thereby utilizing data, the location application may provide the currently cached location of the user device to, for example, a gateway of the wireless communication network. However, in configurations, if the actual location of the user device is available, then the actual location may be provided to, for example, the gateway of the wireless communication network. In particular, in configurations, if the location application and/or user device is configured to fetch the actual location of the user device for certain scenarios, uses, cases and/or conditions, then the actual location may be provided. Use of either of the cached or actual locations may be based upon configuration of the user device and/or the location application, which may be programmed in a way that either of the locations can be used, and in any frequency, based on the type of interaction of the user device with the wireless communication network.

Based upon the received location, the gateway may determine that the user device is located in an area of the wireless communication network, e.g., the United States, for billing purposes and therefore allow the service to be provided to the user device. For example, the gateway may determine that based on the cached location and based upon the amount of elapsed time since the location was cached, the user device has probably not left the United States. Thus, in configurations, the operator of the wireless communication network may configure an accuracy setting for the location of the user device. In configurations, the desired accuracy may be very low. Additionally, in configurations, the cached location of the user device may not be automatically sent to the gateway but rather, the gateway may request the cached location and then based upon the received cached location, provide the service the user device.

In configurations, once the service is being provided to the user device, an actual location of the user device may be determined. The actual location may be determined in a variety of ways. For example, the actual location may be determined based upon a cell global identity (“CGI”) when the service involves the mobile device placing or receiving a call. Emergency (911) messages or calls may also be used to determine an actual location. Registration of the user device within a portion of the wireless communication network may also be used to determine an actual location.

Additionally, the actual location of the user device may be determined when the user device changes a mode of operation or access. For example, the user device may change from accessing the wireless communication network via WiFi to LTE. Likewise, the user device may change from, for example, an airplane mode of operation to a standard (full) mode of operation. A GPS function of the user device may be used in such instances to determine the actual location of the user device. In configurations, the actual location of the user device may be determined even if service is not being requested or service is not being provided to the user device in the wireless communication network. The location of the user device may be updated in the cache (or memory). As previously noted, use of the location application may require consent of the user and thus, local service with respect to location determinations based upon the location application may be requested and provided with the consent of the user.

When the service provided by the wireless communication network to the user device is based upon the use of a third-party application, the actual location of the user device may be determined by the third-party application utilizing the GPS function of the user device. Thus, in configurations, the actual location of the user device may be configured to be fetched from the user device based upon the GPS function of the user device and thereby provided to the wireless communication network.

The newly determined actual location may be stored in the cache (or memory) to update the location of the user device in the cache (or memory). The newly determined actual location may also be provided to the gateway to update the location of the user device. In configurations, the location application may allow for the provision of emergency services for the user device regardless of the cached and/or actual location of the user device. Furthermore, if the actual location of the user device is available, then the actual location of the user device may be provided to the gateway instead of the cached location. This is especially true if the service being requested is a location based service, an emergency service, e.g., a 911 call, etc.

If the actual location of the user device requires a change in billing procedures, then the gateway may update the billing records for the use of minutes for calling and/or for the amount of data usage for the service provided by the wireless communication network. For example, if the actual location has indicated that the user device has left the country, then, based upon the country code, the cost of providing service to the user device may be adjusted. The determined actual location may then be stored in cache on the user device for use by the location application. In configurations, the location of the user device may be stored in memory as opposed to cache.

In configurations, the gateway may determine that the cached location and an amount of time that has elapsed since the cached location may indicate that the user device may have left an appropriate portion of the wireless communication network (e.g., the user device has left the United States). Thus, prior to providing the service to the user device, the gateway may request an actual location of the user device. Additionally, in configurations, the cached location of the user device may be updated periodically based upon the user device moving within the wireless communication network and registering with a cell of the wireless communication network, e.g., a base station or access point, of the cell, to thereby provide an updated location of the user device for the cache.

Thus, by utilizing the location application on the user device and the cached location, delays in providing services to the user device may be reduced. Additionally, the billing for services provided within the wireless communication network may be efficiently handled and updated while providing service to the user device in a more timely fashion. Also, information relating to the locations of user devices within the wireless communication network may be provided and used for diagnostics and analytics by an operator of the wireless communication network. The use of GPS by an operating system of the user device (or other platform location components of the user device) may also be reduced, thereby saving battery usage of the user device.

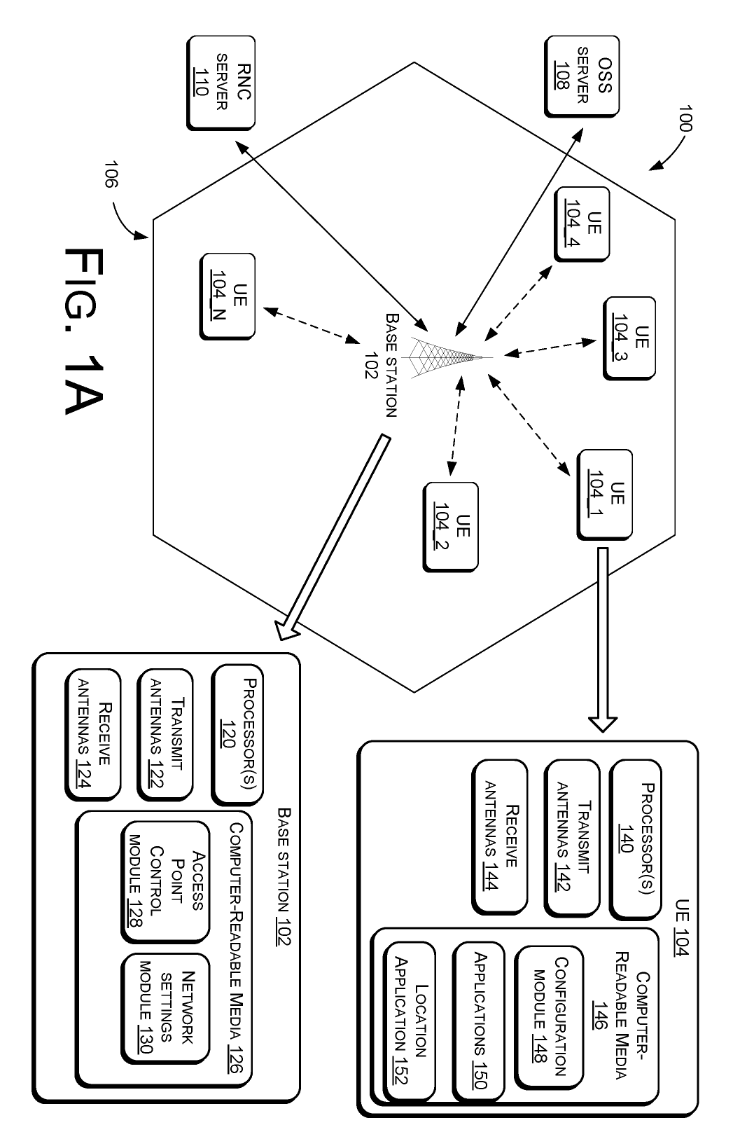

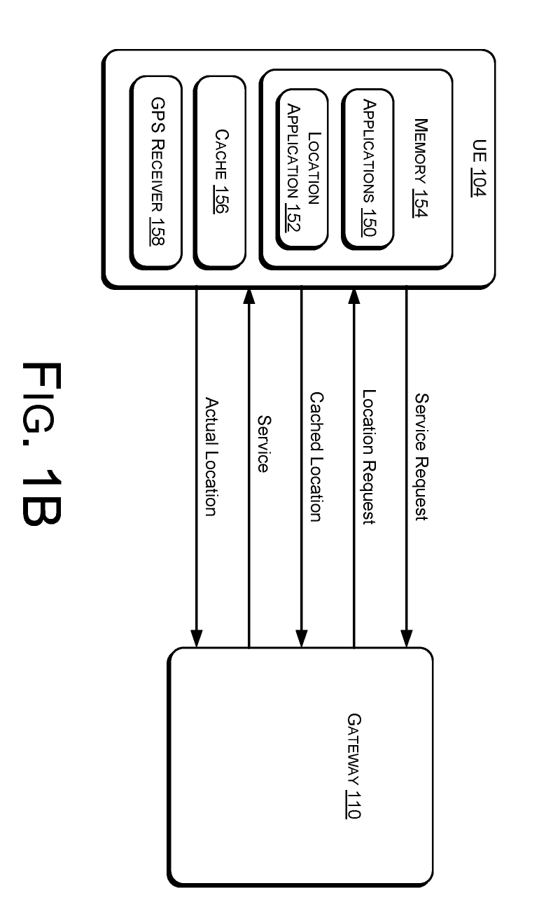

FIG. 1A illustrates a wireless communication network 100 (also referred to herein as network 100). The network 100 comprises a base station (BS) 102 communicatively coupled to a plurality of user devices, referred to as UEs 104_1, 104_2, . . . , 104_N, where N is an appropriate integer. The BS 102 serves UEs 104 located within a geographical area, e.g., within a macro cell 106. FIG. 1A illustrates the macro cell 106 to be hexagonal in shape, although other shapes of the macro cell 106 may also be possible. In general, the network 100 comprises a plurality of macro cells 106, with each macro cell 106 including one or more BSs 102. In configurations, the macro cells 106 may be divided into small cells (not illustrated), e.g., femto cells, pico cells, micro cells, or the like. The multiple macro cells 106 and small cells may be organized into multiple subnetworks that make up the wireless communication network 100. For example, the wireless communication network 100 may be a national network and thus, the wireless communication network 100 may be divided into four regional subnetworks, where each regional subnetwork includes multiple macro cells 106 that may be divided into small cells.

In an embodiment, the UEs 104_1, . . . , 104_N may comprise any appropriate devices, e.g., portable electronic devices, for communicating over a wireless communication network. Such devices include mobile telephones, cellular telephones, mobile computers, Personal Digital Assistants (PDAs), radio frequency devices, handheld computers, laptop computers, tablet computers, palmtops, pagers, integrated devices combining one or more of the preceding devices, and/or the like. As such, UEs 104_1, . . . , 104_N may range widely in terms of capabilities and features. For example, one of the UEs 104_1, . . . , 104_N may have a numeric keypad, a capability to display only a few lines of text and be configured to interoperate with only Global System for Mobile Communications (GSM) networks. However, another of the UEs 104_1, . . . , 104_N (e.g., a smart phone) may have a touch-sensitive screen, a stylus, an embedded GPS receiver, and a relatively high-resolution display, and be configured to interoperate with multiple types of networks. UEs 104_1, . . . , 104_N may also include SIM-less devices (i.e., mobile devices that do not contain a functional subscriber identity module (“SIM”)), roaming mobile devices (i.e., mobile devices operating outside of their home access networks), and/or mobile software applications.

In an embodiment, the BS 102 may communicate voice traffic and/or data traffic with one or more of the UEs 104_1, . . . , 104_N. The BS 102 may communicate with the UEs 104_1, . . . , 104_N using one or more appropriate wireless communication protocols or standards. For example, the BS 102 may communicate with the UEs 104_1, . . . , 104_N using one or more standards, including but not limited to GSM, Internet Protocol (IP) Multimedia Subsystem (IMS), Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), Wi-Fi protocols (including IEEE 802.11 protocols), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like.

The BS 102 may be communicatively coupled (e.g., using a backhaul connection, illustrated using solid lines in FIG. 1A) to a number of backhaul equipments, e.g., an operation support subsystem (OSS) server 108, a radio network controller (RNC) 110, and/or the like. The RNC 110 can also be in the form of a mobility management entity that serves as a gateway when the wireless communication network 100 operates according to the long term evolution (LTE) standard or LTE Advanced standard.

In an embodiment, the base station 102 may comprise processors 120, one or more transmit antennas (transmitters) 122, one or more receive antennas (receivers) 124, and computer-readable media 126. The processors 120 may be configured to execute instructions, which may be stored in the computer-readable media 126 or in other computer-readable media accessible to the processors 120. In some embodiments, the processors 120 are a central processing unit (CPU), a graphics processing unit (GPU), or both CPU and GPU, or any other sort of processing unit. The base station 102 can also be in the form of a Node B (where the wireless communication network 100 is 3G UMTS network) or in the form of an eNode B (where the wireless communication network 100 operates according to the LTE standard or LTE Advanced standard).

The one or more transmit antennas 122 may transmit signals to the UEs 104_1, . . . , 104_N, and the one or more receive antennas 124 may receive signals from the UEs 104_1, . . . , 104_N. The antennas 122 and 124 include any appropriate antennas known in the art. For example, antennas 122 and 124 may include radio transmitters and radio receivers that perform the function of transmitting and receiving radio frequency communications. In an embodiment, the antennas 122 and 124 may be included in a transceiver module of the BS 102.

The computer-readable media 126 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the base station 102. The computer-readable media 126 may reside within the base station 102, on one or more storage devices accessible on a local network to the base station 102, on cloud storage accessible via a wide area network to the base station 102, or in any other accessible location.

The computer-readable media 126 may store modules, such as instructions, data stores, and so forth that are configured to execute on the processors 120. For instance, the computer-readable media 126 may store an access point control module 128 and a network settings module 130, as will be discussed in more detail herein later.

Although FIG. 1A illustrates the computer-readable media 126 in the BS 102 storing the access point control module 128 and the network settings module 130, in various other embodiments, the access point control module 128, the network settings module 130, and one or more other modules (not illustrated, may be stored in another component of the network 100 (e.g., other than the BS 102). For example, one or more of these modules may be stored in a computer-readable media included in the OSS server 108, the RNC 110, another appropriate server associated with the network 100, and/or the like.

Although not illustrated in FIG. 1A, various other modules (e.g., an operating system module, basic input/output systems (BIOS), etc.) may also be stored in the computer-readable media 126. Furthermore, although not illustrated in FIG. 1A, the base station 102 may comprise several other components, e.g., a power bus configured to supply power to various components of the base station 102, one or more interfaces to communicate with various backhaul equipment, and/or the like.

In an embodiment, the UEs 104 may comprise processors 140, one or more transmit antennas (transmitters) 142, one or more receive antennas (receivers) 144, and computer-readable media 146 in the form of memory and/or cache. The processors 140 may be configured to execute instructions, which may be stored in the computer-readable media 146 or in other computer-readable media accessible to the processors 140. In some embodiments, the processors 140 is a central processing unit (CPU), a graphics processing unit (GPU), or both CPU and GPU, or any other sort of processing unit. The one or more transmit antennas 142 may transmit signals to the base station 102, and the one or more receive antennas 144 may receive signals from the base station 102. In an embodiment, the antennas 142 and 144 may be included in a transceiver module of the UE 104.

The computer-readable media 146 may also include CRSM. The CRSM may be any available physical media accessible by a computing device to implement the instructions stored thereon. CRSM may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which can be used to store the desired information and which can be accessed by the UE 104.

The computer-readable media 146 may store several modules, such as instructions, data stores, and so forth that are configured to execute on the processors 140. For instance, the computer-readable media 140 may store a configuration module 148. In configurations, the computer-readable media 146 may also store one or more applications 150 configured to receive and/or provide voice, data and messages (e.g., short message service (SMS) messages, multi-media message service (MMS) messages, instant messaging (IM) messages, enhanced message service (EMS) messages, etc.) to and/or from another device or component (e.g., the base station 102, other UEs, etc.). In a configuration, the computer-readable media 146 may store a location application 152 as will be described further herein. The applications 150 may also include third-party applications that provide additional functionality to the UE 104.

Although not illustrated in FIG. 1A, the UEs 104 may also comprise various other components, e.g., a battery, a charging unit, one or more network interfaces, an audio interface, a display, a keypad or keyboard, a Global Positioning System (GPS) receiver and/or other location determination component, and other input and/or output interfaces.

Although FIG. 1A illustrates only one UE (UE 104_1) in detail, each of the UEs 104_2, . . . , 104_N may have a structure that is at least in part similar to that of the UE 104_1. For example, similar to the UE 104_1, each of the UEs 104_2, . . . , 104_N may comprise processors, one or more transmit antennas, one or more receive antennas, and computer-readable media including a configuration module.

In an embodiment, the network settings module 130 stored in the computer-readable media 126 maintains a plurality of network settings associated with the network 100. Individual network settings maintained by the network settings module 130 may be pertinent to a single UE of the UEs 104_1, . . . , 104_N, a subset of the UEs 104_1, . . . , 104_N, or each of the UEs 104_1, . . . , 104_N. For example, a network setting of the plurality of network settings may specify a maximum bit rate at which a UE (or each of the UEs 104_1, . . . , 104_N) may transmit data to the BS 102. Another network setting of the plurality of network settings may specify a transmit time interval (tti) used by each of the UEs 104_1, . . . , 104_N to transmit data to the BS 102. Yet another network setting of the plurality of network settings may specify a maximum power that each of the UEs 104_1, . . . , 104_N may use to transmit data to the BS 102. The plurality of network settings maintained by the network settings module 130 may also include any other appropriate type of network settings.

In an embodiment, one or more of the plurality of network settings maintained by the network settings module 13 may be communicated to the UEs 104_1, . . . , 104_N (e.g., by the transmit antennas 122 to the receive antennas 144 of the UEs 104_1, . . . , 104_N). Based on receiving the network settings, the UEs 104_1, . . . , 104_N (e.g., the corresponding configuration modules 148) may configure themselves and communicate with the BS 102 accordingly.

FIG. 1B schematically illustrates an arrangement of a UE 104 interacting with the RNC 110 of the wireless communication network 100 of FIG. 1A. The UE 104 generally includes many of the previously mentioned components and/or features. However, for simplicity, the UE 104 is only illustrated as including applications 150 and the location application 152 located in a memory 154, a cache 156 and a GPS receiver 158.

The location application 152 on the UE 104 stores a location of the UE 104 in the cache 156. In a configuration, the location may be stored in the memory 154 and the UE 104 may or may not include the cache 156. When utilizing the location application 152 on the UE 104, a user of the UE 104 may be prompted for permission for the location application 152 to operate and store one or more locations of the UE 104 in the cache 156. Generally, the location application 152 only stores one, fairly recent location in the cache 156. The location application 152, in configurations, may also request the UE 104 to determine the current location of the UE 104 and store it in the cache 156. The UE 104 may determine its current location using any of a variety techniques, including, but not limited to, utilizing a GPS function of the GPS receiver 158, utilizing a CGI, a third party application 150 that may have determined a position of the UE 104 utilizing a GPS function of the GPS receiver 158, etc.

In configurations, the UE 104 requests service from the RNC or gateway 110 within the wireless communication network 100, e.g., to make a call thereby utilizing minutes, or utilize a third-party application 150, thereby utilizing data. The location application 152 may provide the currently cached location of the UE 104 to the gateway 110. In configurations, the cached location of the 104 may not be automatically sent to the gateway 110, but rather the gateway 110 may request the cached location in response to the service request and then, based upon the received cached location, provide the service to the UE 104. However, in configurations, if the actual location of the UE 104 is available, then the actual location may be provided to, for example, the gateway 110 of the wireless communication network 100. In particular, in configurations, if the location application 152 and/or the UE 104 is configured to fetch the actual location of the UE 104 for certain scenarios, uses, cases and/or conditions, then the actual location of the UE 104 may be provided. Use of either of the cached or actual locations may be based upon configuration of the UE 104 and/or the location application 152, which may be programmed in a way that either of the locations can be used, and in any frequency, based on the type of interaction of the UE 104 with the wireless communication network 100.

Based upon the received location, the gateway 110 may determine that the UE 104 is located in an area of the wireless communication network 100, e.g., the United States, for billing purposes and therefore allow the service to be provided to the UE 104. For example, the gateway 110 may determine that based on the cached location and based upon an amount of elapsed time since the location was cached, the UE 104 has probably not left the United States. Thus, in configurations, the operator of the wireless communication network 100 may configure an accuracy setting for the location of the UE 104. In configurations, the desired accuracy may be initially very low since the accuracy of the location of the UE 104 for billing purposes is generally low, e.g., is the UE 104 likely still in the United States.

In configurations, once the service is being provided to the UE 104, an actual location of the UE 104 may be requested. The actual location may be determined utilizing any of a variety of techniques. For example, the actual location may be determined based upon CGI when the service involves the UE 104 placing or receiving a call. Emergency (911) messages or calls may also be used to determine an actual location. Registration of the UE 104 within a portion, e.g., a cell 106, of the wireless communication network 100 may also be used to determine an actual location.

Additionally, the actual location of the UE 104 may be determined when the UE 104 changes a mode of operation or access. For example, the UE 104 may change from accessing the wireless communication network 100 via WiFi to LTE. Likewise, the UE 104 may change from, for example, an airplane mode of operation to a standard (full) mode of operation. A GPS function of the GPS receiver 158 of the UE 104 may be used in such instances to determine the actual location of the UE 104. In configurations, the actual location of the UE 104 may be determined even if service is not being requested or service is not being provided to the UE 104 in the wireless communication network 100. The location of the UE 104 may be updated in the cache 156 (or memory 154). As previously noted, use of the location application 152 may require consent of the user and thus, local service with respect to location determinations based upon the location application 152 may be requested and provided with the consent of the user.

When the service provided by the wireless communication network to the UE 104 is based upon the use of a third-party application 150, the actual location of the UE 104 may be determined by the third-party application utilizing a GPS function of the GPS receiver 158 of the UE 104. Thus, in configurations, the actual location of the UE 104 may be configured to be fetched from the UE 104 based upon the GPS function of the GPS receiver 158 of the UE 104 and thereby provided to the RNC 110. The newly determined actual location may be stored in the cache 156 (or memory 154) to update the location of the UE 104 in the cache 156 (or memory 154).

The newly determined actual location may also be provided to the gateway 110 to update the location of the UE 104. Other techniques may be used to determine an actual location of the UE 104 and the previous techniques mentioned are merely examples that are not meant to be limiting. In configurations, the location application 152 may allow for the provision of emergency services for the UE 104 regardless of the cached and/or actual location of the UE 104. Additionally, in configurations, an actual location of the UE 104 may not be requested by the gateway 110 if the cached location is deemed satisfactory. Furthermore, if the actual location of the UE 104 is available, then the actual location of the UE 104 may be provided to the gateway 110 instead of the cached location. This is especially true if the service being requested is a location based service, an emergency service, e.g., a 911 call, etc.

If the actual location of the UE 104 provided to the gateway 110 requires a change in billing procedures, then the gateway 110 may update the billing records for the use of minutes for calling and/or for the amount of data usage for the service provided by the wireless communication network 100. For example, if the actual location has indicated that the UE 104 has changed countries, then, based upon the country code, the cost of providing service to the UE 104 may be adjusted. The determined actual location may then be stored in the cache 156 on the UE 104 to update the location of the UE 104 for use by the location application 152.

In configurations, the gateway 110 may determine that the cached location and an amount of time that has elapsed since the cached location was stored may indicate that the UE 104 may have left an appropriate portion of the wireless communication network 100 (e.g., the UE 104 has left the United States). Thus, prior to providing the service to the UE 104, the gateway 110 may request an actual location of the UE 104. Additionally, in configurations, the cached location of the UE 104 may be updated periodically based upon the UE 104 moving within the wireless communication network 100 and registering with a cell 106 of the wireless communication network 100, e.g., a base station 102 or an access point, of the cell 106, to thereby provide an updated location of the UE 104 for the cache 156. The cached location of the UE 104 may also be updated periodically based on other techniques for determining the location of the UE 104 discussed herein.

Thus, by utilizing the location application 152 on the UE 104 and the cached location, delays in providing services to the UE 104 may be reduced. Additionally, the billing for services provided within the wireless communication network 100 may be efficiently handled and updated while providing service to the UE 104 in a more timely fashion. The use of GPS by an operating system of the UE 104 (or other platform location components of the UE 104) may also be reduced. Also, information relating to the locations of UEs 104 within the wireless communication network 100 may be provided and used for diagnostics and analytics by an operator of the wireless communication network 100.

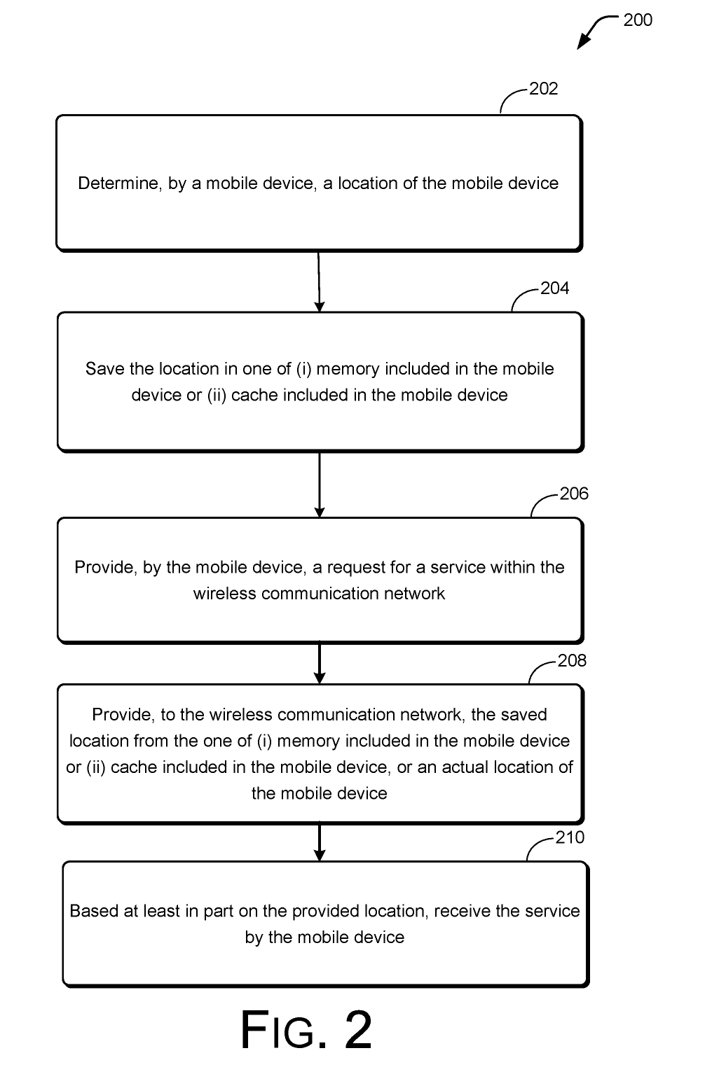

FIG. 2 is a flow diagram of an illustrative process that may be implemented within the wireless communication network 100. This process (as well as other processes described throughout) are illustrated as a logical flow graph, each operation of which represents a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Furthermore, while the architectures and techniques described herein have been described with respect to wireless networks, the architectures and techniques are equally applicable to processors and processing cores in other environments and computing devices.

FIG. 2 is a flowchart illustrating a method 200 of providing services to a mobile device, e.g., UEs 104, by a wireless communication network, e.g., wireless communication network 100, based upon a cached location of the portable electronic device. As illustrated, at block 202, a mobile device determines a location of the mobile device. At block 204, the location is saved in one of (i) memory, e.g., memory 154, included in the mobile device or (ii) cache, e.g., cache 156, included in the mobile device. At block 206, a request is provided by the mobile device for a service within the wireless communication network. At block 208, the saved location is provided to the wireless communication network from the one of (i) memory included in the mobile device or (ii) cache included in the mobile device, or an actual location of the mobile device may be provided instead of the saved location. At block 210, based at least in part on the provided location, the service is received by the mobile device.

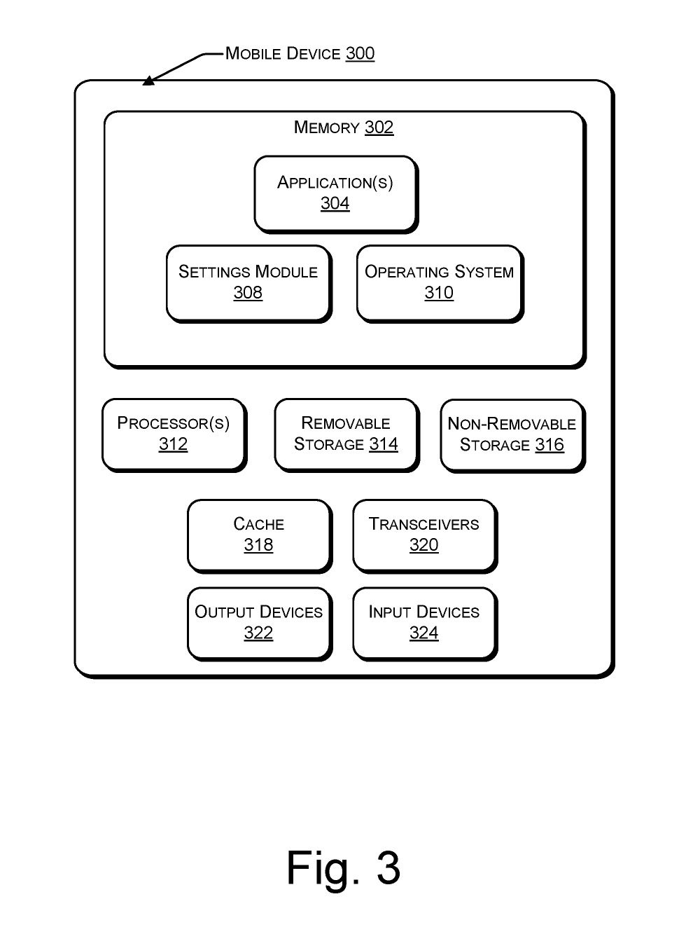

FIG. 3 schematically illustrates a component level view of a mobile device 300, such as UE 104, configured to function within wireless communication network 100. As illustrated, the mobile device 300 comprises a system memory 302, e.g. memory 154, storing application(s) 304, e.g., applications 150 and location application 152, a settings module 308, and an operating system 310. Also, the mobile device 300 includes processor(s) 312, a removable storage 314, a non-removable storage 316, transceivers 318, output device(s) 320, and input device(s) 322. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit.

The mobile device 300 may also include additional data storage devices (removable and/or non-removable) such as, for example, magnetic disks, optical disks, or tape. Such additional data storage may include removable storage 314 and non-removable storage 316. Additionally, the mobile device 300 includes cache 318, such as cache 156, for storing one or more locations of the mobile device 300.

Non-transitory computer-readable media may include volatile and nonvolatile, removable and non-removable tangible, physical media implemented in technology for storage of information, such as computer readable instructions, data structures, program modules, or other data. System memory 302, removable storage 314, non-removable storage 316 and cache 318 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the user device 300. Any such non-transitory computer-readable media may be part of the user device 300. The processor(s) 312 may be configured to execute instructions, which may be stored in the non-transitory computer-readable media or in other computer-readable media accessible to the processor(s) 312.

In some implementations, the transceivers 320 include any sort of transceivers known in the art. For example, the transceivers 320 may include a radio transceiver that performs the function of transmitting and receiving radio frequency communications via an antenna. Also or instead, the transceivers 320 may include wireless modem(s) to may facilitate wireless connectivity with other computing devices. Further, the transceivers 320 may include wired communication components, such as an Ethernet port, for communicating with other networked devices.

In some implementations, the output devices 322 include any sort of output devices known in the art, such as a display (e.g., a liquid crystal display), speakers, a vibrating mechanism, or a tactile feedback mechanism. Output devices 322 also include ports for one or more peripheral devices, such as headphones, peripheral speakers, or a peripheral display.

In various implementations, input devices 324 include any sort of input devices known in the art. For example, input devices 324 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 324 may be used to enter preferences of a user of the mobile device 300 to define how the user wishes certain calls from third parties to be handled by the wireless communication network, as previously described herein.

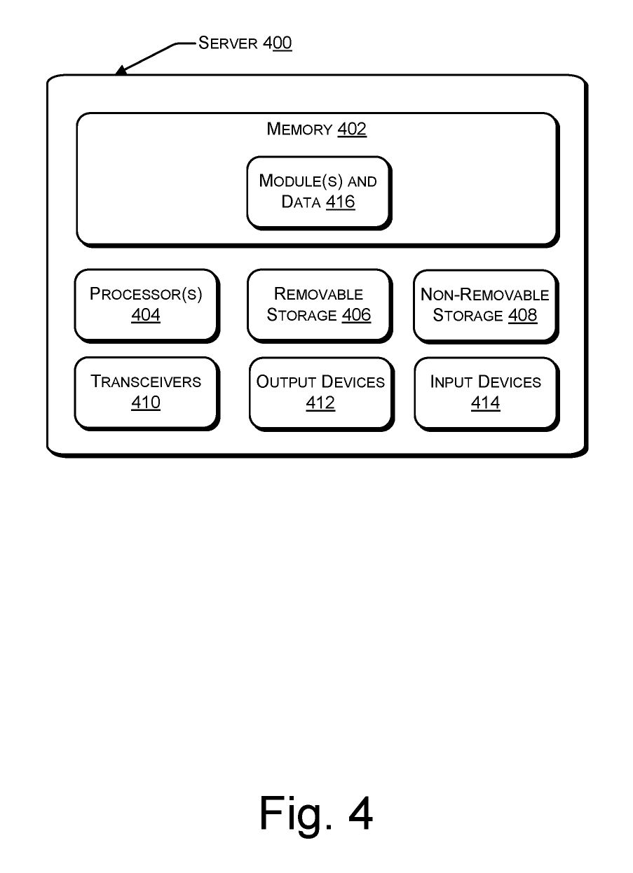

FIG. 4 illustrates a component level view of a server configured for use within a wireless communication network, e.g., wireless communication network 100 in order to provide various services within the wireless communication network, according to the techniques described herein. The server 400 may be located in the RNC or gateway 110. Additionally, the server 400 may be a separate entity located separately from the RNC 110. As illustrated, the server 400 comprises a system memory 402 that may store data and one or more modules and/or applications 416 for interacting with mobile devices 300, e.g., UEs 104, as described herein. Also, the server 400 includes processor(s) 404, a removable storage 406, a non-removable storage 408, transceivers 410, output device(s) 412, and input device(s) 414.

In various implementations, system memory 402 is volatile (such as RAM), non-volatile (such as ROM, flash memory, etc.) or some combination of the two. In some implementations, the processor(s) 404 is a central processing unit (CPU), a graphics processing unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 406 and non-removable storage 408. The one or more of the memory 402, the removable storage 406 and/or the non-removable 408 may include module(s) and data 416 (illustrated in the memory 402). The module(s) and data 416 may include instructions executable by, for example, the processors 404.

Non-transitory computer-readable media may include volatile and nonvolatile, removable and non-removable tangible, physical media implemented in technology for storage of information, such as computer readable instructions, data structures, program modules, or other data. System memory 402, removable storage 406 and non-removable storage 408 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 410 include any sort of transceivers known in the art. For example, the transceivers 410 may include wired communication components, such as an Ethernet port, for communicating with other networked devices. Also or instead, the transceivers 410 may include wireless modem(s) to may facilitate wireless connectivity with other computing devices. Further, the transceivers 410 may include a radio transceiver that performs the function of transmitting and receiving radio frequency communications via an antenna.

In some implementations, the output devices 412 include any sort of output devices known in the art, such as a display (e.g., a liquid crystal display), speakers, a vibrating mechanism, or a tactile feedback mechanism. Output devices 412 also include ports for one or more peripheral devices, such as headphones, peripheral speakers, or a peripheral display.

In various implementations, input devices 414 include any sort of input devices known in the art. For example, input devices 414 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method within a wireless communication network, the method comprising:
determining, by a mobile device, a location of the mobile device;
saving the location in one of (i) memory included in the mobile device or (ii) cache included in the mobile device to provide a saved location;
providing, by the mobile device to a gateway of the wireless communication network, a request for wireless service within the wireless communication network;
providing, by the mobile device to the wireless communication network, the saved location from the one of (i) memory included in the mobile device or (ii) cache included in the mobile device; and
receiving, by the mobile device, wireless service from the wireless communication network, the wireless service being based at least in part on the saved location.

2. The method of claim 1, further comprising:
receiving, by the mobile device, a request for the saved location,
wherein providing the saved location from the one of (i) memory included in the mobile device or (ii) cache included in the mobile device comprises providing the saved location from the one of (i) memory included in the mobile device or (ii) cache included in the mobile device in response to the request.

3. The method of claim 1, further comprising:
based at least in part on the received wireless service, updating the saved location related to the mobile device in the one of (i) memory included in the mobile device or (ii) cache included in the mobile device with a current location.

4. The method of claim 3, wherein updating the saved location related to the mobile device in the one of (i) memory included in the mobile device or (ii) cache included in the mobile device with current location comprises updating the saved location based upon a cell global identity (CGI) or by utilizing a GPS function of the mobile device.

5. The method of claim 1, further comprising:
determining, by the mobile device, a current location related to the mobile device.

6. The method of claim 5, further comprising:
subsequent to receiving the wireless service by the mobile device, providing, by the mobile device, the current location related to the mobile device to the gateway.

7. The method of claim 1, further comprising:
receiving, by the mobile device, a request for an initial location related to the mobile device;
determining the initial location; and
storing the initial location in the one of (i) memory included in the mobile device or (ii) cache included in the mobile device.

8. The method of claim 1, wherein the wireless service comprises an emergency call and the method further comprises:
placing the emergency call by the mobile device regardless of the saved location provided by the mobile device.

9. The method of claim 1, wherein determining, by the mobile device, the location of the mobile device comprises determining the location of the mobile device based upon a cell global identity (CGI).

10. The method of claim 1, wherein determining, by the mobile device, the location of the mobile device comprises determining the location of the mobile device by utilizing a GPS function of the mobile device.

11. A mobile device comprising:
cache;
one or more processors;
a non-transitory storage medium; and
instructions stored in the non-transitory storage medium, the instructions being executable by the one or more processors to:
determine a location of the mobile device;
save the location in one of (i) the non-transitory storage medium or (ii) the cache to provide a saved location;
provide a request to a gateway of a wireless communication network for wireless service within the wireless communication network;
provide the saved location from the one of (i) the non-transitory storage medium or (ii) the cache to the wireless communication network; and
receive, by the mobile device, wireless service from the wireless communication network, the wireless service being based at least in part on the saved location.

12. The mobile device of claim 11, wherein the instructions are further executable by the one or more processors to:
receive a request for the saved location; and
provide the saved location from the one of (i) the non-transitory storage medium or (ii) the cache in response to the request.

13. The mobile device of claim 11, wherein the instructions are further executable by the one or more processors to:
based at least in part on the received wireless service, update the saved location related to the mobile device in the one of (i) the non-transitory storage medium or (ii) the cache with a current location.

14. The mobile device of claim 13, wherein the instructions are further executable by the one or more processors to update the saved location related to the mobile device in the one of (i) the non-transitory storage medium or (ii) the cache with a current location based upon a cell global identity (CGI) or by utilizing a GPS function of the mobile device.

15. The mobile device of claim 11, wherein the instructions are further executable by the one or more processors to:
determine a current location related to the mobile device.

16. The mobile device of claim 15, wherein the instructions are further executable by the one or more processors to:
subsequent to receiving the wireless service by the mobile device, providing, by the mobile device, the current location related to the mobile device.

17. The mobile device of claim 11, wherein the instructions are further executable by the one or more processors to:
receive a request for an initial location related to the mobile device;
determine the initial location; and
store the initial location in the one of (i) the non-transitory storage medium or (ii) the cache.

18. The mobile device of claim 11, wherein the wireless service comprises an emergency call and wherein the instructions are further executable by the one or more processors to:
placing the emergency call by the mobile device regardless of the saved location provided by the mobile device.

19. The mobile device of claim 11, wherein the instructions are further executable by the one or more processors to:
determine the location of the mobile device based upon a cell global identity (CGI).

20. The mobile device of claim 11, wherein the instructions are further executable by the one or more processors to:
determine the location of the mobile device by utilizing a GPS function of the mobile device.
